(19) United States
(12) Patent Application Publication
(10) Pub. No.: US 2019/0383359 A1
(43) Pub. Date: Dec. 19, 2019

(54) WIND TURBINE WITH TWO-STAGE STAR COMPOUND GEAR TRAIN

(71) Applicant: Delbert Tesar, Austin, TX (US)

(72) Inventor: Delbert Tesar, Austin, TX (US)

(21) Appl. No.: 16/270,589

(22) Filed: Feb. 7, 2019

Related U.S. Application Data
(60) Provisional application No. 62/627,745, filed on Feb. 7, 2018.

(51) Int. Cl. F16H 1/20; F03D 15/00; F16H 1/22; H02K 7/18; F03D 9/25; F16H 57/02

(52) U.S. Cl. CPC F16H 1/206; F03D 15/00; F16H 1/22; F16H 2057/02034; F03D 9/25; F16H 57/02; H02K 7/183

(57) ABSTRACT

A wind turbine is provided. The wind turbine comprises a blade; a shaft which rotates in response to the rotation of said blade; a generator; and a star compound gear train disposed between said shaft and said generator.

### CROSS-REFERENCE TO RELATED APPLICATION

This application claims the benefit of priority of U.S. provisional application No. 62/627,745, filed Feb. 7, 2018, having the same inventor and the same title, and which is incorporated herein by reference in its entirety.

### FIELD OF THE DISCLOSURE

The present disclosure relates generally to wind turbines, and more particularly to wind turbines equipped with star compound gear trains.

### BACKGROUND OF THE DISCLOSURE

A conventional wind turbine is depicted in FIG. 7. As seen therein, the wind turbine 101 includes a nacelle 103 mounted on a tower 105. The nacelle 103 is equipped with a rotor 107. The rotor 107 includes a plurality of blades 109 set at a certain pitch and a hub 111.

The nacelle 103 and tower 105 house various mechanical components that allow the wind turbine to operate effectively to convert wind energy into electrical energy. These components are well known in the art, and include a low speed shaft 113, a brake 115, a gear box 117, a generator 119, a high speed shaft 121, a wind vane 123, an anemometer 125, a controller 127, a yaw drive 129, a yaw motor 131, and swivel beading 133.

Existing wind turbine designs commonly utilize good electrical designs that are paired with weak mechanical technologies. These turbines frequently utilize heavy, poorly designed gear trains whose architectures have no operational choices to avoid failures and to maximize efficiency.

In general, a maximum of only 59.3% of wind energy is available from wind turbines, with an expected extraction of 70% to 80% of that maximum (42% to 48%). Rotor/blade rotational speed is predominantly governed by the wind speed, as indicated by the typical turbine response to wind speed indicated in TABLE 1 below.

TABLE 1
Typical Turbine Response to Wind Conditions

| Turbine Response | Wind Speed |
|---|---|
| Cut in speed | 10 mph |
| Use pitch control to limit maximum | 35 mph |
| power | |
| Cut out speed | 90 mph |
| Survival speed | 130 mph |

### BRIEF DESCRIPTION OF THE DRAWINGS

FIG. 1 is an illustration of a wind turbine development strategy.

FIG. 2 is an illustration of a particular, non-limiting embodiment of a multi-speed turbine generator with an associated tabulation of some exemplary turbine and generator speeds in accordance with the teachings herein.

FIG. 3 is an illustration of a particular, non-limiting embodiment of wind turbine speed shift modules in accordance with the teachings herein.

FIG. 4 is a tabulation of multi-speed wind turbine gear amplifiers.

FIG. 5 is a plan view of a particular, non-limiting embodiment of a multi-speed turbine generator in accordance with the teachings herein.

FIG. 6 is a side view of the multi-speed turbine generator of FIG. 5.

FIG. 7 is a perspective view of a prior art wind turbine.

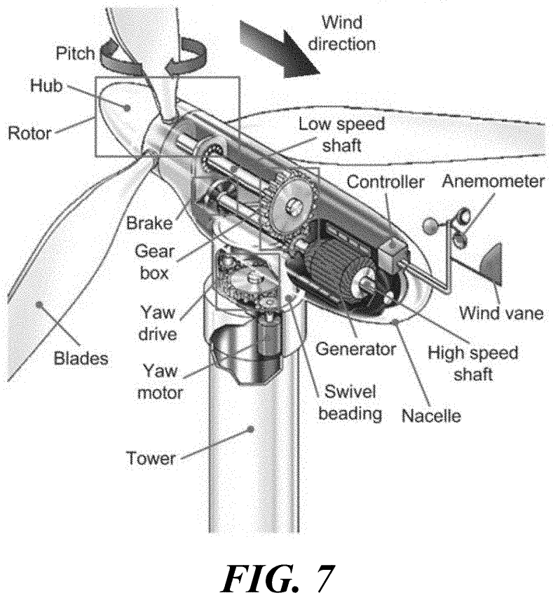

### SUMMARY OF THE DISCLOSURE

In one aspect, a wind turbine is provided which comprises a blade; a shaft which rotates in response to the rotation of said blade; a generator; and a star compound gear train disposed between said shaft and said generator.

### DETAILED DESCRIPTION

The power available to a wind turbine increases with the square of blade length. However, blade weight is a function of the cube of its length. The current target generator speed for many wind turbines is 1800 RPM, which is typically associated with a blade rotor speed of 20 RPM. This presents a need for a gear speed amplifier of 90-to-1. It is to be noted that amplification ratios are relatively rare in gear applications, and thus are not well-founded based on field experience.

Permanent magnets are a particularly expensive component of most wind turbine systems. Geared systems allow for a significant reduction in the need for permanent magnets. Thus, geared systems often use about 50 lbs./kW of permanent magnets, while direct drive (no gears) systems use about 500 lbs./kW of permanent magnets. Further rapid wind speed changes require rapid system response, which is challenging for amplification systems that increase generator inertia I_{g} by the square of the amplification ratio (ex: 90×90×I_{g}=8100 I_{g}). Hence, it is desirable to employ the smallest possible gear inertia and generator inertia.

Unfortunately, the blade hub of many wind turbines is made of heavy cast iron. Generally, a 2× increase in tower height increases available power by ⅓. This enables the use of 2× longer blades, which increases the power by 4× (or an actual increase of 4×1.33=5.33×). The total weight of a typical 5 MW wind turbine is now estimated at 1.1 mil lb. Typical component costs for a wind turbine are summarized in TABLE 2. It has been estimated that operations/maintenance represent 25% of the life cycle cost of a wind turbine.

TABLE 2
Typical Turbine Component Cost

| Component | Cost (as a % of Total Cost) |
|---|---|
| Tower | 22% |
| Blades | 18% |
| Gearbox | 14% |
| Generator | 8% |

The power extracted by a blade is a function of blade pitch. In particular, the power extracted can be reduced to zero from 100% by varying the blade pitch from 0° to 15° away from the design pitch.

Choice of generator type is also an important design consideration, and has a direct bearing on the efficiency and cost of the wind turbine. Common generator types and their attributes are set forth in TABLE 3.

TABLE 3
Turbine Generator Types

| Generator Types | Attributes |
|---|---|
| Induction (IG) | Lowest Cost |
| Permanent Magnet Synchronous (PMSG) | Most Efficient |
| Doubly Fed Induction (DFIG) | Match Grid Frequency |

In many wind turbines, maximum power capacity is reached at 34 mph when the pitch is changed to maintain this power level (and no more). Notably, most power is generated at the higher speeds (above 20 mph) in the operating regime. Unfortunately, lower speeds occur much more frequently than higher speeds. This underscores the advantages that may be obtained by providing design choices such as speed ratios, subsystem modules and generator types. For example, matching generator optimum speeds can increase power generation by 8 to 15%. Here, it is to be noted that doubly-fed induction generators (DFIGs) allow a ±30% speed variation assisted by pitch control (and gear ratio choices if available) with 70% of this flexibility/power coming from the stator. DFIGs generates roughly 2× more power than comparable Permanent Magnet Synchronous Generators (PMSGs).

J. Tamura, (Japan), Springer-Verlag, 2012, “Calculation Method of Losses and Efficiency of Wind Generators”, notes that blade pitch control is very effective in reducing turbine capacity (see TABLE 4). Tamura reports that gear sliding losses are very low (perhaps at 1%). Nonetheless, these sliding contacts can be very destructive to gear teeth, and can result in dramatic failures. Power generation is found to be nonlinear from 14 to 28 mph, and then relatively constant at Cp=1 (5 MW). Gearing and gear windage losses are very small, while iron losses are somewhat larger at 35 kW (0.7%).

TABLE 4
Turbine Generator Types

| Angle (β) (degrees) | Capacity (Cp) |
|---|---|
| 0 | 1 |
| 10 | 0.7 |
| 20 | 0.3 |

At present, gearbox solutions for wind turbine subsystems, turbine blades and power generators are heavy, high cost, failure-prone devices. Once in place, these devices offer no configuration or pass-through choices that would allow pitch to permit blade attitude torque control or that would allow voltage/controller management for the generator to enable efficiency enhancement. Moreover, conventional gearboxes need cost/weight reduction, and should also offer speed ratio choices to maximize energy extraction and significantly reduce operational and maintenance costs.

Anna Bonanomi, Power Transmission World (2017) summarizes the development of design software packages to more rapidly achieve a balanced approach to the parametric design of complex gear transmissions (especially those that operate at very high power levels, and yet are required to be lightweight and cost effective). The reference explains that original gearboxes used offset helical gears in 2 to 3 stages (much like vehicle transmissions), enabling power levels up to 0.75 MW. These were superseded by the use of a planetary epicyclic gearboxes (input at the cage and output at the sun gear) to get power levels up to 2 MW, usually using a follow-up helical gear stage. Two options were commonly used to get this up to 5 MW. One option involved splitting the power from a bull gear to drive two generators. The second option involved the use of two planetary gear sets in series with a follow-on helical gear stage. Most of these designs used local amplification ratios of 6 to 7-to-1, which are extremely high ratios for amplifying velocity in the gear mesh. The multi-power split (two power channels) were typically used in a 6.5 MW design to reduce weight by 25% and volume by 15%. Designs are currently underway to develop gearbox transmissions for up to 12 MW.

U. Giger, K. Arnaudov, “High Efficiency High Torque Gearboxes . . . ” (2012) provides a unique gearbox design based on an expanded planetary module to handle 7.5 mil. ft-lb. of torque in a given speed ratio from 40 up to 135-to-1. Input speeds from 10 to 16 RPM are matched to output speeds of 400, 1200, and 1800 RPM. The goal was to reduce transmission windup and poor dynamic response due to high mass content (i.e., due to the square of the inertia content of the high-speed components and the generator rotor). The recommended design couples 3 epicyclics in series with some parallel connections. Eight planets are utilized in each epicyclic to distribute load, but put a high demand on the sun gears. The final amplifier stage is a large output helical gear driving two small pinions, which drive two separate generators. The paper recommends cantilever gearing shafts for the planet gears to equalize mesh forces on the sun/internal gear (a flex pin 1960 concept by Hicks reinforced by G. Fox at Timken), and also offers the correction factors in TABLE 5 (suggested with a 10% overload factor) for durability.

TABLE 5
Correction Factors

| Correction Factor (Ky) | Load |
|---|---|
| −1.5 | 20% |
| −1.2 | 50% |
| 1.1 | 100% |

In this design, gear widths from 10″ to 20″ are used with internal gear diameters at 24″ (down from 40″) with the use of small planets and larger sun gears. They suggest a length reduction of 20%, high safety factors, and a weight reduction of 70%.

F. Oyague, “Gearbox Modeling . . . ”, NREL Report (2009) is a major report by the National Renewable Energy Laboratory on the parametric modeling of wind turbine gearboxes, with emphasis on vibration modes and lubrication. The report makes the claim that there is a major weakness in the design of those gearboxes, and that gearbox maintenance represents 38% of the O&M. Their overview looks at the basic structure of the Nacelle system, as summarized in TABLE 6.

TABLE 6
Turbine Nacelle Structure Types

| Structure | Attributes |
|---|---|
| Distinct Modules | Blades, gearbox, generator, hub/bearing |
| | must all be tied rigidly together by the |
| | Nacelle bedplate structure, all from |
| | different suppliers. |
| Integrated Subsystems | All principal modules are tied together |
| | without dependence on the Nacelle |
| | bedplate. Collaboration among suppliers is |
| | necessary. Maintenance complexity |
| | increases. |
| Partially Integrated | The gearbox and generator are structurally |
| | tied together. |
| Direct Drive | No gearbox is used, resulting in a very |
| | heavy, large, generator with very high rotor |
| | inertia. The permanent magnet cost is also |
| | very high. |

Generally, better blade design and higher blade diameters lower turbine rotary speeds. This makes larger gear amplification ratios necessary, putting higher demands on gearbox design. The need for higher ratios then suggests more stages in the gearbox. The wind turbine community frequently uses single plane epicyclic gearing with a cage as the input and a sun gear as the output. Such systems typically have a common amplification ratio of 5- to 6-to-1, where the sun is ⅕ the diameter of the internal fixed gear (as explained below, star compound gearing actually excels over epicyclic gearing in this application). The large planet gears carry ⅓ of the load, while the small sun gear carries all the load. Also, the bearings on the planets must carry an unnecessarily high load (which is a major gearbox failure point).

In general, a disk brake is located at the generator far from the high inertia blade rotor. This arrangement can result in high transmission shaft windup, and free motion shock due to backlash in the gear meshes. Mechanisms for blade pitch control in such systems must typically be very responsive to reduce torque spikes in the transmission system. Torsional shafts in these systems must typically be stiff to reduce energy storage (note that stiffness K∝r⁴ where r is a shaft radius). Hollow shafts can be quite stiff, yet relatively light. The vibration frequencies in these systems are often 1.2 Hertz, which is quite low. Considerable oscillating energy can occur in the gearbox transmission.

Energiforsk, J. Ukonsarri, et. al., “Wind Turbine Gearboxes” (2016) provides a very detailed report on gearbox design for wind turbines. The recommended first stage is a cage driven planetary epicyclic gear train with an internal gear diameter of 50″, a planet gear diameter of 22″, and a sun gear diameter of 7.3″. This arrangement provides an amplification ratio of 7.85. Unfortunately, the sun gear diameter is very small. For 5 MW, the input torque is 1,754,000 ft-lb., which puts an exceptionally high load on the planet bearings of:

$${F}_{pl} = \frac{\text{1,754,000}}{3 \times 1.192} = \text{490,500} lb . \qquad ( EQUATION 1 )$$

By contrast, if a configuration is employed which uses split power on a 108″ bull gear with five 45″ follower drive gears, the drive axis bearing load would be:

$${F}_{f} = \frac{\text{1,754,000}}{5 \times 1.875} = \text{187,100} lb . \qquad ( EQUATION 2 )$$

This first bearing load is 2.62× less than the first planet load. Furthermore, the 45″ drive wheel bearing is stationary and can be enclosed in a rigid steel envelope, while the floating planet bearing necessarily exists in the weakest structural envelope for space and weight reasons. This contrast is why present high Megawatt gearbox bearings frequently fail. Going downstream in the gearbox to the results presented in the MSTG design, the first gear train in module A has a 20″ pinion gear with an input torque of 146,180 ft-lb. This means that the first stationary star gear bearing carries a load of:

$${F}_{s 1} = \frac{\text{146,180}}{3 \times 0.833} = \text{58,495} lb . \qquad ( EQUATION 3 )$$

which is a reduction of 8.4× the load on the floating planet bearing in a front-end planetary epicyclic gear train. About 70% of present gearbox failures are in this overloaded planet bearing (Tauner, 2011, Windstat Report 2012). This class of failure has been found to typically require 6 to 15 days to fix, with an annual failure rate of 0.1 to 0.15 failures per turbine. Broken teeth on these overloaded planet/sun gears also occur (although less frequently). The industry would like an 85% availability at full load over 5 years (44,000 hours). Note that industrial robot actuators are available for 100,000 hours. A 20-year span of mixed loading would require 175,000 hours. Past designs have had a 30% to 40% availability. Hence, the gearbox requires significant improvements in design and architecture.

Some useful guidance is made available for gearbox design in this report. They recommend the following safety factors:
Ky=1.25 tooth surface fatigue
Ky=1.53 tooth bending fatigue.
   The report suggests a required availability of bearings to be 90% for a 5-year fully loaded lifetime (i.e., the equivalent of a 20-year partially loaded lifetime). Unfortunately, the community uses gear mesh amplification ratios of 6 or 7-to-1, which is very high. The report also recommends the following load factors:
Ky=1.18 dynamic load factor
Ky=1.20 Bearing load factor
   Finally, the report suggests cooling to keep temperatures below 250° F., and a clean lubricant with little water content (0.3% water results in a loss of life duration of as much as 17% over 20 years).

The Energiforsk 2016 report provides a very useful gearbox weight listing for various available systems for wind turbines. The most representative value was 68,000 lb. for a 5 MW system. In the preliminary analysis given for the modular wind turbine based on 5 MSTG subsystems, the weight of each MSTG gearbox is predicted to be 4000 lb., or for 5, a total of 20,000 lb. Compared to the report, in a 68,000 lb. system, this is a factor improvement of:

$$\frac{\text{68,000}}{\text{20,000}} = 3.4 \times \qquad ( EQUATION 4 )$$

or, a percent weight reduction of 63%. Not only does weight go down, but 60 alternate configurations are available, with virtually 100% availability, lower O&M cost and increased performance-to-cost ratios (higher efficiency).

Large expenditures are currently being made in the wind energy extraction industry. Exceptional work has been achieved in making turbine blades longer and more efficient. The power generators in these devices have benefitted from the long history of their development for use in coal/gas power generating plants.

Unfortunately, wind turbines operate at increasingly slower speeds. At these speeds, normal generators produce power at very low efficiencies. Hence, speed amplification through gearboxes is desirable to reduce weight (which is very high in direct drive systems) and to obtain rotor speeds for generators near 2000 RPM. This situation requires speed amplification (not speed reduction, as is normal in gearing).

Unfortunately, the gear community has little experience with speed amplification, which thus results in high failure rates, high M & O and extended downtimes. Also, since wind speeds vary a great deal (from 5 to 30 mph), the blade rotor and generator rotors typically operate over a large range of speeds. This reduces energy extraction to about 22%. To exacerbate matters, the need to maintain power generators in their efficiency (torque/speed) sweet spot requires shifting speed ratios (as in an automobile transmission). This is something that few, if any, wind turbines do today. Moreover (and unlike modern computer systems), most wind turbines are monolithic and are not modular. Hence, component integration, weight, maintenance downtime, and system cost are unnecessarily high in these systems.

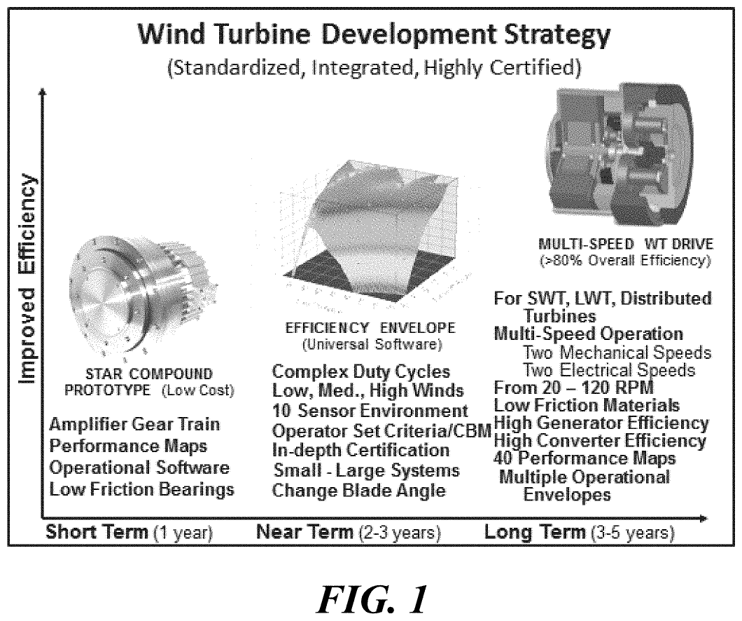

A rebalancing of the electrical and mechanical technologies is described herein, with the intent to allow the best of each to contribute to a more cost-effective wind turbine tech base. This may be further understood with the help of a brief description of ten topics associated with this future tech base. The development of a modular, reconfigurable gearbox is desirable in order to allow the tech base to maximize choices, increase efficiency, reduce cost, eliminate single points of failure, and enable rapid assembly, repair, and refreshment (see FIG. 1). The tabulation of these objectives is given in TABLE 7, which is found to result in an overall factor benefit of 138×.

TABLE 7
REQUIRED TECH BASE DEVELOPMENT

| Development Topic | Description | Suggested Benefit Factor |
|---|---|---|
| Efficiency | To increase wind turbine | 1.33x |
| | efficiency by 33% | |
| Weight | To reduce gearbox weight by 2 | 2-3x |
| | to 3x | |
| Cost | To reduce production cost of the | 2x |
| | MSTG (Multi-Speed Turbine | |
| | Generator) module by designing | |
| | minimum sets in a responsive | |
| | supply chain | |
| Multiple Speed Configurations | To provide 4 distinct speed ratios | 2x |
| | to best match Turbine and | |
| | Generator rotor speeds | |
| No Single Point Failure | Up to 5 MSTGs enables one to | 2x |
| | fail with 4 remaining | |
| | operational. Conservative | |
| | parametric design enables a full | |
| | 20-year durability. | |
| Rapid Repair | Plug-and-play interfaces enable | 1.5x |
| | module removal/replacement in | |
| | one hour | |
| Gearbox Design Principle | Concentrate on the science of | 2x |
| | backdrivable gearing in star | |
| | compound structures with low | |
| | (2.5 to 1) speed amplification | |
| | ratios, low contact sliding | |
| | velocities, high gear tooth | |
| | numbers, low tooth load stresses, | |
| | and low bearing loads. | |
| Sensor-Based Operations | Distributed sensors to create data | 1.5x |
| | flow (in 10-100 msec.) to | |
| | enable full real-time | |
| | modeling/decision making for | |
| | enhanced configuration | |
| | management. | |
| Multiple Generator Classes | Three well developed generator | 1.2x |
| | classes are available (IG, PMSG, | |
| | DFIG) to populate the MSTG | |
| | depending on cost, | |
| | durability, efficiency, etc. | |
| | objectives. | |
| Simplified Controllers | The MSTG embedded | 1.2x |
| | configuration choices put less | |
| | demands on the generator | |
| | controllers so they can be | |
| | targeted to simpler objectives at | |
| | low cost. | |
| | Overall Factored Benefit | 138x |

The best practices in today's turbines provides 30% extraction (the average is 22%). The MSTG multi-speed system may raise this to 40%, a 33% improvement. Note that lower generator speeds may lose 50% of the energy, while at higher (design) speeds, they may lose only 10%. Hence, higher speed amplification (augmented by some blade pitch control) may be desirable in some applications. Gearbox speed ratio change becomes a completely viable, but untried, approach. To make the MSTG useful, only small steps in amplification ratios are feasible for good design. Also, tooth pressure angles up to 25°, more and smaller teeth to reduce sliding velocities, and outstanding lubrication is recommended.

Wind turbines of 5 to 10 MW may be quite heavy. Also, to maximize access to good wind currents, they are typically tall. Hence, weight must be reduced whenever possible, especially in the gearbox. Eliminating the gear box dramatically increases generator weight (perhaps 10×). A multiple epicyclic gear train by Giger, et. al. purportedly reduces gearbox weight by 70% relative to standard units now widely used. A standard gearbox for a 5 MW turbine weighs 68,000 lb. Using 5 MSTGs in a modular configuration, with 4 speeds each, may reduce this weight to 25,000 lb. for a benefit of 2.72× (a 60% reduction). Also, it is recommended to use one large diameter (small cross-section) cross roller bearing with the shortest distance between it and the yaw bearing to further reduce the weight within the nacelle of the turbine.

One of the principal lessons that may be taken from the computer industry is to design in-depth, and in minimum sets (all highly certified), to continuously improve performance-to-cost ratios. Present gearbox cost is 14% of the total wind turbine cost. Using a strategy similar to that adopted by the computer industry, this cost may be reduced to 7-10%. One useful strategy is to use a power split from a large bull gear (for 5 MW, 108″ is recommended) to drive five 45″ gears, which then drive the 5 MSTG subsystems. Each of the MSTG subsystems is largely modular (modules A, 1, 2, and the selected power generator) to represent a 1 MW device. This open architecture substantially improves availability of the wind turbine by maintaining the operation of 4 MSTGs when one is taken offline.

Remarkably, the lessons learned from auto transmissions (engine torque/speed demand matching) have not been utilized in wind turbine gearboxes, although the need exists to improve energy extraction and to enhance durability. Unfortunately, these gearboxes typically need to increase output velocity in order to be more useful (most transmissions increase output torque—the opposite of what is needed here). The result is heavy, excessively loaded systems with low durability systems and high bearing failure rates. Hence, a whole set of new design priorities must now be established for multi-speed turbine generator (MSTG) gearboxes.

In a preferred embodiment of a system disclosed herein, 5 MSTGs are utilized, each with 4 speeds and a selection of different classes of power generators (IG, PMSG, DFIG), to best match wind speed distribution at a given site. These 5 MSTGs, 4 speeds, and 3 generator classes represent a minimum of 60 distinct configurations to best match wind speed demands, reduce cost, enhance durability, and reduce down time. Each MSTG subsystem may be designed with 4 speed ratio options to take 10 to 20 RPM of the turbine rotor to best match the torque/speed efficiency sweet spot of the selected power generator operating at 1500 to 2000 RPM. One suggested set of speed ratios is 50, 66.6, 100, 133.3. Other choices might be to idle one or more of the MSTGs to enhance performance of those remaining in operation.

The concept of no single points of failure is widely used in computers. For example, reliability is the estimate of time to failure. However, availability, which is often critical to wind turbines, depends on reconfiguration to avoid the impact of a failure (with perhaps some reduction in performance—i.e., limp home). Taking out a failed generator may be implemented by putting a clutch in the MSTG in neutral.

Present gearboxes are failure prone, representing a 50% failure rate in the first few years of operation. This failure rate is largely due to poor design, resulting in overloaded bearings and an associated reduction in reliability. Alternate configurations provide high availability—a crucial requirement for lower O & M cost, which now represents 25% of the system's total life cycle cost. Conservative design parameters (such as, for example, low tooth contact and bending stresses, low gear ratios, larger diameter gears, no radial loads on central shafts, all bearings in rugged fixed wall structures) may reduce the potential for fatigue fractures and may provide sufficient durability for a 20-year lifetime.

The history of wind turbines demonstrates a low priority to efficiently manage failure and repair. The poor integration of present subsystems actually results in frequent nacelle fires. Repair personnel now must perform complex operations at high elevations with poor support (two people carrying out a myriad of physical/technical tasks). As indicated before, M & O represents 25% of life cycle cost. Gearboxes in the U.S. from 2003-2009 represented 160,000 hours of downtime (the most of any subsystem). Generators had the least downtime.

A quick plug-and-play change-out of the MSTG gearbox is disclosed herein which uses a connecting spline on its front shaft to tie into the axle shaft of one of the five 45″ drive gears (that mesh with a 108″ bull gear). This interchange with an on-site spare is expected to be feasible in one hour. A dexterous gantry crane may be utilized to take the (e.g., 5000 lb.) module off its rail and move it to a tower elevator, which would take it to the tower base. The gearbox module may then be transported by land or sea to a dedicated repair facility, where expert, well-trained personnel can perform suitable repairs on it. This approach is especially important for offshore wind turbines.

The use of longer blades for higher MW wind turbines results in lower blade rotor speeds, which in turn require higher speed ratios in order to best match efficient generator rotor speeds (this issue is discussed in greater detail below). Hence, the key requirement is speed amplification, something rarely considered in the gear community. This is frequently labeled back drivability. Higher contact friction at high speed ratios can be very inefficient, and may even result in lockup. Hence, very low mesh ratios (say, from 2.5 to 3.0) are necessary. Furthermore, it is useful to have large numbers of shorter (preferably helical) teeth (with 25° pressure angles) on all gears with contact ratios of 2 or more.

Energieforsch describes a 50″ diameter internal gear for an epicyclic frontend to a gearbox with 22″ planet gears and an 8″ sun gear for a 5 MW system. Unfortunately, this sun gear is too small. Such a gearbox/generator combination will weigh 50 lbs./kW, while a generator without a gearbox would weigh 500 lbs./kW (i.e., a factor of 10× higher). Clearly, gearboxes are needed, but the widely used epicyclic gear box represents a poor design choice.

For example, the planet bearing on a 5MW epicyclic will experience a 490,500 lb. peak load. The bearing on a 45″ drive gear of the MSTG sees a load of 187,100 lb., a factor of 2.62× less. Furthermore, the first operational bearing load in a star gear in the MSTG would then be 55,700 lb. lb, or 8.8× less. Note that all the MSTG bearings are in a fixed housing, strongly reinforcing the bearing races. This demonstrates that carefully selected design principles can reduce the threat of bearing failure almost to zero. Bearing failures occur predominantly in the epicyclic gear train, since the cage is connected directly to the wind turbine drive shaft. This arrangement puts a very high torque load on the planet bearings, with a low 1.2 ft. moment arm. The gears have to be 10 to 20″ wide and arranged in a single plane epicyclic. The planet bearings are unprotected inside a limited-thickness gear rim with an amplification ratio of 6 to 7-to-1.

A few 5 MW systems use a power split at a front-end bull gear or a power split at the backend of the gear box to operate two power generators. While potentially helpful, these rather simple options do not get at the heart of the architectural limitations of these gearboxes. In particular, measures of this type do not offer configuration choices to best match wind speed to needed (most efficient) power generator speeds.

Real-time operational data (speed, temperature, load, forces, torque, voltage, current) from low-cost sensors (for cars, these average $1 each) make it possible to make decisions in 10 to 100 msec. These decision speeds allow the host system to react effectively to loading, speed, and power grid changes so as to best manage system configuration choices. Such management may include condition monitoring to improve performance, to predict failure, and to obtain timely repair by plug-and-lay. Such effective decision making reduces O & M costs and maximizes availability.

For example, large velocity amplification ratios (g) increase the effective inertia content of power generator rotors I_{g} relative to the blade rotor as follows:

Ī_{g}=I_{g}(g)² (EQUATION 5)

If g=100, then Ī₉=10,000I_{g}. This makes I_{g} of the same order of magnitude as the blade rotor Ī_{b}, such that these two masses are separated by an effective torsional spring K̅₉. Such a torsional spring can be the basis for vibrational oscillations due to wind blade shock (torque spikes due to high wind turbulence). This situation requires corrective action at the generator to cancel the oscillation energy, making it imperative to reduce gear train backlash (free motion) and increase torsional stiffness K̅_{g}. Both of these can be dealt with by low amplification ratios and high gear tooth stiffness (2 or 3 teeth in contact).

The era of “smart machines” is producing a spectrum of technologies to treat highly nonlinear machines with a wide range of configuration choices to maximize performance, durability, efficiency, rapid response to command, and other performance criteria. Here, this includes choices within the MSTG (such as, for example, speed changes, declutching, and generator torque management (+/−)) and among multiple MSTGs (such as, for example, on/off, efficiency balancing, and vibration/noise management). This era of intelligence is described in a recent paper: The Next Wave of Technology, D. Tesar, Taylor and Francis Group, 10.1080/10798587.2015.1118202.

Three classes of proven power generators exist. These are:

TABLE 8
Power Generator Types

| Power Generator | Description | Attributes |
|---|---|---|
| IG | Induction | Low-Cost/Least Efficient |
| PMSG | Permanent Magnet | Most Efficient/Higher Cost |
| | Synchronous | |
| DFIG | Doubly Fed Induction | Match Grid Frequency, |
| | | 2x more Power |
| | | Dense than PMSG |

All of these generator types work well with gearbox amplification ratios getting them to 1500 to 2000 RPM. Each may have special features that may be best suited to a given wind distribution at an intended site. This flexible choice may be mixed and chosen to best match wind distributions during the first year of operation.

Unfortunately, direct drive (DD) generators (no gear box) are exceptionally heavy and massive. They typically achieve 50% losses at low wind speeds because the generator is operating far away from its torque/speed sweet spot. Furthermore, there is very little control flexibility to fix this weakness. The DD generators may be 65 to 80 ft. in diameter, and may weigh up to 150,000 lb. Because of their large inertial mass, they do not respond to rapidly changing wind patterns very well.

Recent emphasis on wind turbine controllers has increased the cost and complexity of these devices. Generally, the IG requires the simplest and least expensive controller. The PMSG requires rapid high current pole switching, which results in some complexity and cost. The DFIG requires the most expensive and complex controller. Fortunately, these controllers are all quite efficient with low losses.

The MSTG allows special selection of a mixed array of generators and controllers to best suit the wind distribution experienced at a site. After a period of operation (say, 1 year), these power generators may be reconsidered and interchanged with more efficient matches to the needs of the site. All controllers should use embedded birth certificate performance maps (the selected generators) to enable fast and accurate response to wind conditions. These performance maps may degrade over time. However, this degradation may be quantified (by differencing real-time maps with the originals) to accurately predict time to failure (time to repair) or to better set operational criteria to best optimize efficiency based on real-time decision making.

It is a goal of the present disclosure to modernize and rebalance the electrical and mechanical technologies used in wind turbines to provide enhanced availability, lower cost, improved design choices for local wind patterns, reduced overall weight, and rapid repair and refreshment. In a preferred embodiment of a system disclosed herein, this is achieved by providing 5 gear/generator modules, each representing 4 speed ratios, driving a high RPM (1500-2000) generator where all gears are designed for speed amplification to improve their durability and reduce load demands on key bearings.

The history of poorly designed gear amplifiers has led to a greater emphasis on electrical technologies leading to direct drive generators of exceptional size, weight, and cost which results in high demands on tower structures and prevents deployment in off-shore locations. As previously noted, wind turbines can extract about 30% of the wind energy. This number could be improved to 40% (a 33% improvement) by making it possible to keep the generator operating in its torque/speed sweet spot of maximum efficiency.

Wind speed patterns vary greatly, making it necessary to change the speed amplification ratio at 4 levels over a ratio range of 4 to 5×. Longer turbine blades reduce their maximum speed from roughly 30 RPM to 15 RPM in most wind patterns. This reality results from the need to keep the tip speed to wind speed ratio (TSR) near 7 or 8. Also, the tip speed must be kept below 180 mph to reduce noise, vibrations, and tip vortex losses. These lower turbine speeds do extract more energy, but place a higher burden on the design of the multi-speed gear amplifier system to maximize generator efficiency. The power coefficient (Cₚ) is very nonlinear over the TSR range of 1 to 9. Further, the specific system losses are relatively higher (roughly 50%) at lower TSR values, reaching values of less than 5 to 10% at higher TSR values. Much of these low-speed losses are due to poor efficiency of low air gap speeds in the generator.

The foregoing has forced suppliers to go towards low speed range gear amplifiers and larger diameter generators, or to direct drive, very large diameter generators (which in total may weigh 250,000 lb.). For example, one direct drive system requires 400 poles and 3600 slots, and has a diameter of 80 ft. and a narrow width of 1 ft. Under perfect conditions, it may extract 84% of the available energy (although normally, the energy extraction is 50% or less because of low wind speed distribution). Another embodiment of the direct drive is 65 ft. in diameter and is equipped with a 5 ft. long generator which runs at 18 RPM and weighs 50,000 lb. (not counting the supporting structure which weighs another 50,000 to 100,000 lb.).

Another issue is the necessity to match the 60 cps timing of the power supply grid system. Pitch control can modify the turbine speed somewhat, but at a great loss in energy extraction.

The gear community has little practical history in gear amplifiers (motion speed up—not speed reduction). This means that loads go down as speeds go up. The gear history in wind turbines suggests 50% failure in the first few years, which is far short of the desired 20-year lifetime. Furthermore, these gear systems are very expensive, and experience high losses in critical bearings.

Moreover, gear mesh ratios are high at 5 to 6-to-1 in archaic epicyclic gear structures. The input to the epicyclic gear train in such systems is typically at the cage, and output is at the sun gear. The cage contains 3(+) planet gears supported by bearings in the cages, all of which require exceptional care in design parameter selection. None of this is founded on design recommendations specifically targeted to speed amplification. The input loads are extremely high (700,000 ft-lb. for a 1.5 MW turbine). To reach 5 MW is now necessary, but is beyond gear design standards. There is thus a need to consider an amplification from 16.7 RPM to 1500 RPM (at the generator) with a speed increase of 90×. Some designs use two epicyclics in series, with one or two offset gear meshes. TABLE 9 provides tabulated downtime on wind turbines from 2003-2009 on a component-by-component basis.

TABLE 9
Downtime on Wind Turbines (2003-2009)

| Component | Average Down Time (hrs) |
|---|---|
| Gears | 160,000 |
| Generator | 110,000 |
| Electrical System | 120,000 |
| Rotor/Blades | 65,000 |

The average downtime for each repair is 6 to 12 hours. The desired number of bearing/gear revolutions over 20 years is 10¹⁰, which is an extraordinarily high number. This history now suggests that a new approach is essential in order to reduce cost and to improve availability in wind turbine systems.

One recommendation for improving wind turbine designs is to provide an improved structural bearing support for the wind turbine blade hub by using a large diameter, small cross-section cross roller bearing as the main bearing. These bearings have extraordinary load capacity values in all force directions (thrust, radial, and out-of-plane moments) necessary for the complex force histories associated with wind turbines. The torque may then be transferred to a large diameter (perhaps 108″) bull gear to drive a series of 1 MW multi-speed generator modules. The history of gear design has used mesh ratios of 4 to 5-to-1. Here, the amplification ratios are preferably 3× (or, if possible, 2.5×) to reduce the increased wear potential in amplifier gears. Also, all teeth will preferably use 25° pressure angles with addenda reduced by 20%. Finally, all driven gears will have high numbers of teeth (24 up to 27) to better distribute loads, wear and friction.

Most first-stage gear amplifiers for wind turbines are based on the classical epicyclic gear assembly equipped with a moving cage. The cage carries planets running in bearings at relatively high speeds within the fragile structure of the cage. The reality is that this is actually one of the least attractive gear assemblies. A better gear assembly is the star compound gear assembly. This gear assembly has many of the same geometric features as the epicyclic gear assembly, but is equipped with shafts in stationary back walls (hence, the cage is not a moving cage). The back walls themselves may be of a strong and rugged configuration. Each pinion is preferably surrounded symmetrically by 3 or more star gears. This arrangement permits the use of clutches to engage adjacent pinions to drive a different star gear set, thus allowing amplifier ratios to be changed in a very simple arrangement. This use of the star compound gear assembly is a primary reason this proposed gear system is particularly suited to wind turbine applications.

Present wind turbines typically have maximum rotational speeds of 15 to 20 RPM. Wind patterns drive these systems from 3 up to 20 RPM. Unfortunately, at low speeds (3 to 5 rpm) and high torque, electric generators designed for high speeds (say, 2000 RPM) and lower torque will be very inefficient (say, at 30 to 50%). Hence, it is desirable to provide multi-speed gearing with a shift ratio of 4 to 5, with 4 carefully chosen gear ratios (each ≤2× faster) to best match the wind patterns at a given turbine farm site (see FIG. 1).

In light of the foregoing, in one preferred embodiment of the wind turbines disclosed herein, a device is provided which includes 4 to 5 one MW gear/generator modules. Each of the gear/generator modules is driven by a primary bull gear (9× faster) with helical gear teeth and a preferred width of 4 inches. Preferably, two amplifier meshes of 3 to 1 are provided to drive the first input pinion of the 4-speed gear/generator module. Each of the 5 modules preferably includes a front end, 2-speed, high torque velocity amplifier module and a backend, 2-speed, lower torque velocity amplifier module. The foregoing preferably drive the generator near its designed maximum efficiency sweet spot at 2000 RPM.

Each gear module is expected to weigh approximately 5000 lb. Each module will preferably be designed with a standard quick-change interface to attach to the bull gear as the principal driver of the system. The gear/generator modules may then be produced in quantity with carefully chosen internal shift ratios to reduce cost and improve performance. The use of 5 gear/generator modules eliminates single point failures in the system. In particular, if a failure occurs in one of the modules, that module can be declutched and taken out of service, leaving the 4 remaining modules to continue operation. A spare could be on hand to then replace the failed gear/generator module. The failed module could be taken down an elevator to the tower base for transfer to a remote repair facility (very important for expanded off-shore turbine deployment). Each module would have embedded sensors to provide data for condition monitoring to predict failures or reduced performance. All of this is intended to reduce cost, maximize availability, and allow the wind turbine to operate at improved energy efficiency.

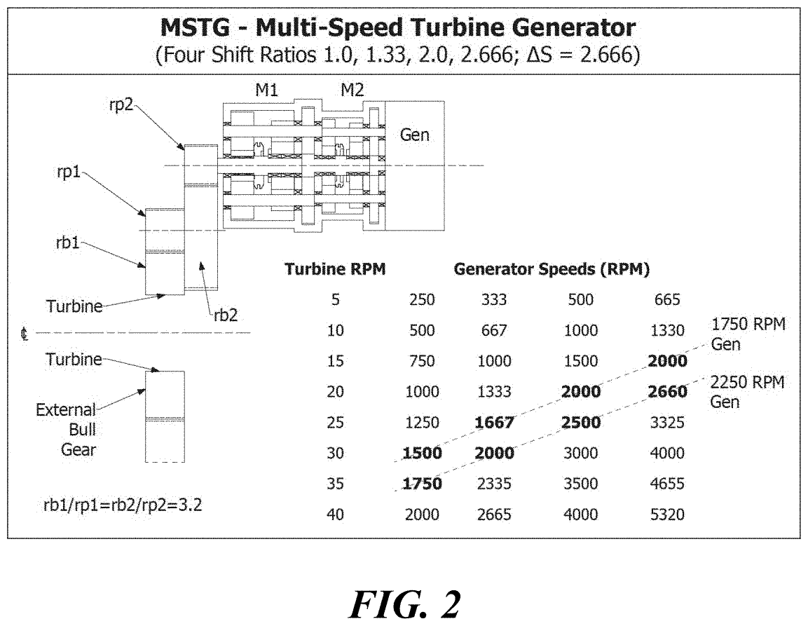

Each site at which a wind turbine is installed will have specific requirements driven by local wind patterns. Hence, this section is a rather simple parametric study of a generic gear reducer subsystem. In a preferred embodiment, each gear system is driven by two gear meshes at the bull gear where the first mesh would be a 30/10 or 36/12 inch pair of gears approximately 4″ wide. This may reduce the 1 MW torque of 466,000 ft-lb. to 52,000 ft-lb. entering into the front end shift module M1. As shown in FIGS. 1-2, the mesh ratios are:

$$\frac{{r}_{1}}{{r}_{2}} = 1.0 , \frac{{r}_{3}}{{r}_{4}} = 1.333 , \frac{{r}_{6}}{{r}_{5}} = 2.0 \qquad ( EQUATION 6 )$$

where the clutch engages either gear r₁ or r₃. This module then drives shift module M2 with mesh ratios:

$$\frac{{r}_{7}}{{r}_{8}} = 1.0 , \frac{{r}_{9}}{{r}_{10}} = 2.0 , \frac{{r}_{12}}{{r}_{11}} = 2.0 \qquad ( EQUATION 7 )$$

to give a total internal shift of:

| | | | |
|---|---|---|---|
| 1.0 | 1.33 | 2.0 | 2.666. |

This shift is then increased by 8× up front and 6.25× at the back to 50× to give total shift ratio values of:

| | | | |
|---|---|---|---|
| 50 | 66.7 | 100 | 133 |

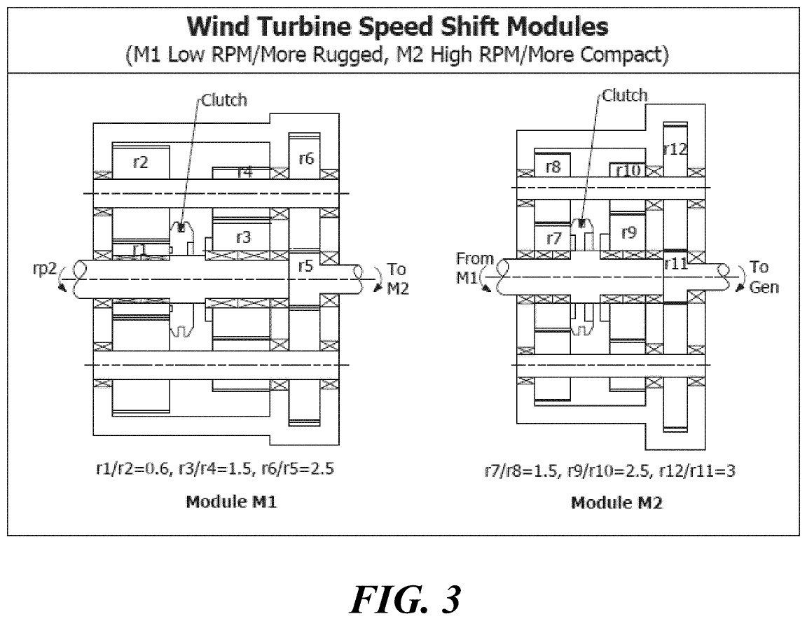

(see FIGS. 2-3). For an expected range of turbine speeds, the available generator speeds in RPM would be as shown in TABLE 10.

TABLE 10
Turbine and Generator Speeds

| Turbine RPM | | | Generator RPM | | |
|---|---|---|---|---|---|
| 5 | 250 | 333 | 500 | 665 | |
| 10 | 500 | 667 | 1000 | 1330 | |
| 15 | 750 | 1000 | 1500 | 2000 | Line 1 |
| 20 | 1000 | 1333 | 2000 | 2660 | Line 2 |
| 25 | 1250 | 1667 | 2500 | 3325 | |
| 30 | 1500 | 2000 | 3000 | 4000 | |
| 35 | 1750 | 2335 | 3500 | 4655 | |
| 40 | 2000 | 2665 | 4000 | 5320 | |

It is to be noted that large 5 MW turbines only get to 20 RPM in rare high winds of 30-40 mph, and 25 RPM in winds of 40 to 50 mph. The above ratios may be adjusted to best meet the wind distribution at a given site. These turbine RPM values may also be adjusted (in small ranges) by blade pitch control. Some wind distributions may be flat from 0 to 20 mph with a peak at 12 mph, while the sharp distributions have a peak at 17 mph. Both distributions may have useful wind speeds at 50 mph. Hence, the higher amplification ratios are needed much more at the lower speeds such that design at 10 to 20 mph is a primary range to yield a turbine blade speed of 10 to 20 RPM.

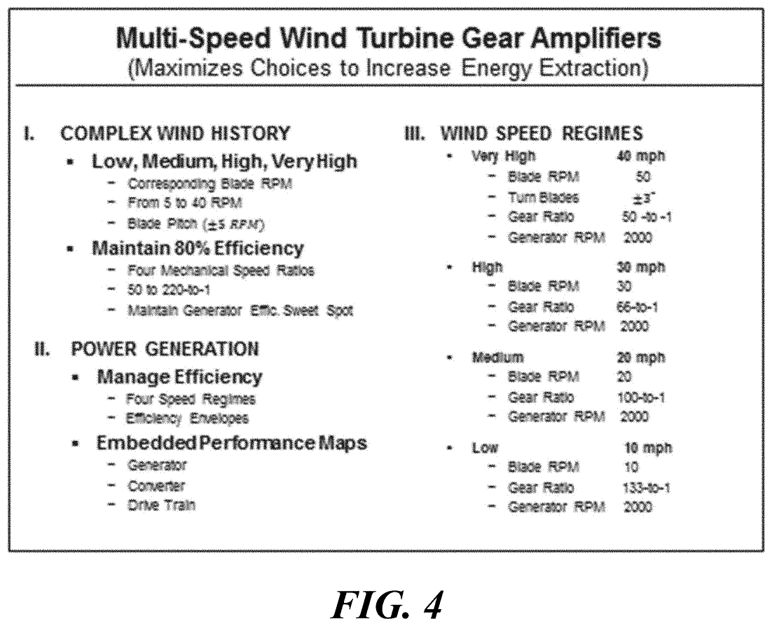

Reviewing the above shift RPM values, it is apparent that Line 1 generator speeds (1500-2000; see TABLE 10) are best suited to a 1750 RPM generator, while Line 2 speeds (1750-2660; see TABLE 10) are best suited to a 2250 RPM generator. All of this suggests the complexity inherent in the wind turbine design process. Further, similar complexity exists at the operational level in maximizing energy generation. In practice, it is recommended that a schedule of recommended amplifier ratios be sampled to best match the generator's most efficient torque speed sweet spot. Some modules may be declutched (taken out of service) to improve choices for those modules remaining in service. Blade pitch may change turbine torque/speed levels. The ultimate goal is maximum energy recovery, while also matching the grid frequency of 60 Hertz. This suggested technical rebalancing of the electrical and mechanical tech bases is intended to do just that (see FIG. 4).

In order to increase design choices, it may be useful to consider an intermediate star compound frontend Module A to drive Module 1 in the 1 MW generator subsystem. In this case, in FIG. 3, rₚ₁ may be 45″ in diameter with a 2.4-to-1 amplification ratio relative to the 108″ bull gear r_{b1}. In such an embodiment, rₚ₁ would preferably directly connect (through a spline shaft with a 27.4″ pinion gear rₚ₂) to drive a 15″ star gear rₛ₂ which, in turn, would be connected to another star gear rₛ₃ (of 27.4″) to drive an output gear rₚ₃ of 15″. The output gear rₚ₃ would preferably connect directly to the input shaft of the switching Module 1. This frontend would then have a total amplification ratio of:

R=2.4×1.85×1.85=8

with the goal of reducing tooth sliding velocities (and bearing loads) on the heavily loaded teeth at the frontend of this 1 MW subsystem.

Sudden wind gusts may create sudden torque spikes (2x the existing level) which may be very damaging. Torque sensors may be utilized to send signals to the generators to create a canceling torque spike to reduce the damage that would otherwise occur from these torque shocks.

### IV. Basic Design Criteria for Gear Back-Drivability

It is a goal of the present disclosure to provide designs for gear velocity amplifiers (back-drivability) for various applications. Such applications include not only energy recovery applications in wind and water turbines, but energy recovery in other applications as well, such as braking systems for vehicle wheels. Other applications include, but are not limited to, orthotics to respond to human force command, haptics in robot surgery, and fire control for the military. Some or all of these applications may involve an inversion of the normal gear design rules (force amplification) so as to achieve maximum gear mesh efficiency. This may enable velocity amplification even under significant loads.

Gearing has been used to transmit power from one rotating axis to another for centuries, where the primary goal has been to amplify force/torque while reducing velocity. This still remains necessary, since electric prime movers require high relative air gap velocities to create significant power from low magnetic field forces. Hydraulic systems have transferred high power/force by means of high pressure, but at low efficiencies and low durability. Electro-mechanical actuators for robot industrial manipulators have a life durability of 100,000 hours, which is 20× of that of the average automobile. This durability is now needed in a very wide range of force amplification applications (including, without limitation, aircraft control surface operation, drive wheels for cars, trucks, trains, and highly repetitive manufacturing operations).

Presently, a need is emerging to develop gears to amplify motion (inputs from humans, low velocity wind turbines, the equivalent of catapults, etc.). This amplification will preferably respond precisely to a wide variety of signal parameters (such as, for example, position, velocity and force) in real time. To do may require a series of small step-ups in velocity with minimum friction (high efficiency) while still maintaining accurate transfer of the signal properties.

Preferred embodiments of the systems and methodologies disclosed herein leverage one or more of seven key design rules on back-drivability. These design rules are described below.

The first design rule is the use of a series of small velocity increases to obtain a large increase in velocity. This means that most gear ratios will increase angular velocity by 3×, or less.

The second design rule is to use as many teeth as possible while still being able to carry the mesh load. This means that the tooth module will move towards the range of 1 to 3 and away from the range of 7 to 10.

The third design rule is to increase the pressure angles from 14° to 25° which reduces losses by 2×. The goal is to have the shortest line of action possible.

The fourth design rule is to reduce the tooth addendum height by up to 20% to reduce losses by approximately 1.2×. This shortens the line of action and reduces interference, but may increase noise levels at higher speeds.

The fifth design rule is to use the best available, low viscosity lubricant with specific emphasis on temperature and pressure viscosity losses. Testing shows that if the contact pressure goes down by 2×, losses will go down 2×, and if temperature affects go down 3×, then the losses go down 1.5×.

The sixth design rule is to use chemical finishing to reduce sharp asperities that result in surface point-to-point force contacts.

The seventh design rule is that large amplification ratios (say 100-to-1) result in a reflected effective inertia as the square of the ratio (say, 10,000×), making upstream disturbances (or command inputs) ineffective.

Preferred parameters for the principal gears in the devices and systems disclosed herein are set forth in TABLE 11 below.

TABLE 11
Principal Gear Parameters

| Parameter | Value |
|---|---|
| Diametral Pitch | Module from 1 to 10 |
| Tooth Ratio | 5 to ⅕ |
| Forward/reduce | 5 to 1 |
| Backward/Amplify | 1 to ⅕ |
| Pressure Angle | 20° to 26° |
| Mesh Velocity | 100 to 700 ft/sec. |
| Mesh Tooth Load | Tangential |
| Gear Width | — |
| Helix Angle | 10° to 30° |

Various supporting gear parameters may be adjusted or modified to improve or optimize performance of the wind turbines and their components as disclosed herein. These include, without limitation, addendum reduction (tooth relief), surface finish, surface hardness, steel quality, I and J factors, gear accuracy, and gear alignment.

Various measurements may be utilized to gauge the performance of wind turbines and their components as disclosed herein. These include, without limitation, friction, efficiency, interference, contact stresses, bending stresses, tooth bending, geometry factors, line of action numbers (∈₁, ∈₂, ∈₁/∈₂, ∈₀), and Life (10⁶-10¹⁰) (up to 20 years).

Reference is made herein to gear module (m). A lower module implies more teeth. Hence, a module of 1 implies many small teeth, and a module of 10 implies a small number of large teeth. For a 4″ diameter gear with 15 teeth, m=6/667. With 10 teeth, 50 teeth, and 100 teeth, m is 10, 2 and 1, respectively.

Reference is also made to contact ratios. This describes the length of the line of action before and after the pitch point (nₐ, nᵣ). Here, the contact ratio is given by:

$${n}_{c} = \frac{{L}_{ab}}{p Cos φ} \qquad ( EQUATION 7 )$$

where
L_{ab}—line of action
p—circular pitch
Ø—pressure angle

### Then,

L_{ab}=rₚ sin Ø+r_{g} sin Ø (EQUATION 8)

where rₚ, r_{g} are the radii of the pinion and gear.

Reference is also made herein to interference. This concept describes the smallest number of teeth Nₚ on a pinion gear that do not result in interference. For example, let mᵣ=N_{q} Nₚ be the gear ratio. Then:

$${N}_{p} = \frac{2 k}{( 1 + 2 {m}_{g} ) {sin}^{2} φ} ( {m}_{r} + \sqrt{( m\_r \hat{} 2 ) + ( 1 + 2 {m}_{r} ) sin {2}_{φ} )} \qquad ( EQUATION 9 )$$

Here, k is the height of the addendum (say, k=0.8 for a 20% reduction). Clearly, mᵣ involves the ratio of the number of teeth in the gear pair. For backdriving, it is desirable for mᵣ to be relatively small (e.g., 2.5 or 3.0).

The mechanical design/architecture of existing wind turbines has largely stagnated in favor of investigating electrical technology base options such as, for example, the direct drive of low RPM, and heavy and expensive large-diameter electrical generators. One alternative disclosed herein is the creation of a modular system based on MSTG modules with 4 switchable speeds to reduce cost, increase efficiency, improve availability, and reduce weight. Each MSTG module may be designed for quick plug-and-play repair interchange, optimized low ratio velocity amplification (back-drivability) gearing for minimal mesh/bearing forces, and a selection of different electric generators (IG, PMSG, DFIG) to maximize choices to respond rapidly to wind speed changes and to maximize availability.

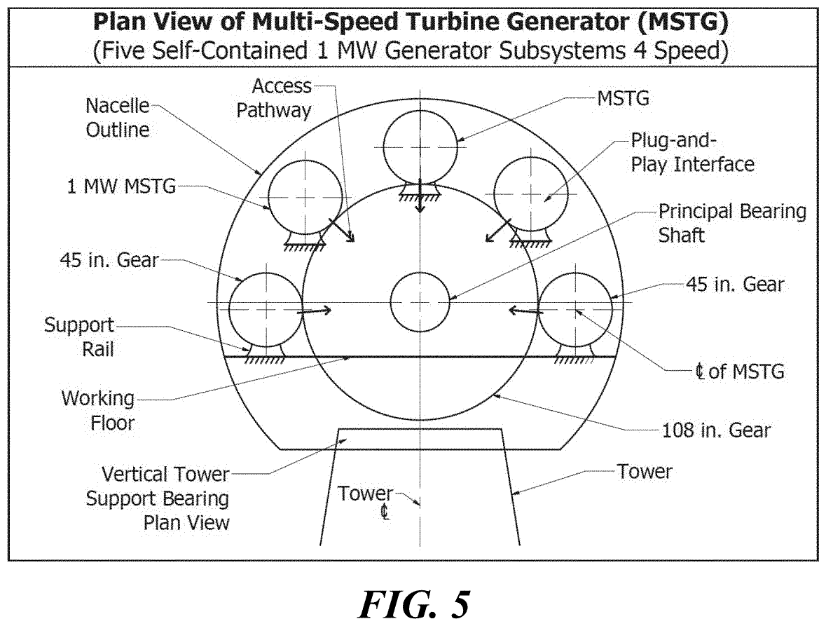

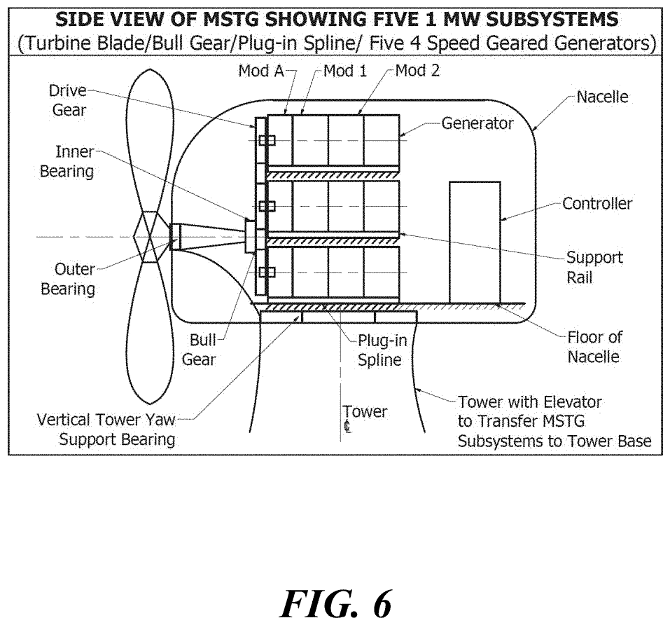

The Multi-Speed Turbine Generator (MSTG) is preferably configured as a standardized module which may be utilized as multiples (say, 5 at 1 MW each) to make up a 5 MW wind turbine. It preferably uses the back-drivability principal of the previous section to design the simplest gears of exceptional ruggedness (as characterized, for example, by low contact and bending stresses, low contact sliding velocities, and high surface finish-chemical/hardening). These MSTG modules will preferably be assembled on a multi-rail cylindrical array to permit rapid removal and replacement if repair is needed (see FIGS. 5-6). Each rail may support an MSTG module. A dexterous crane may be utilized to transport the module in an out of the array and then take it to a tower elevator to lower it to the tower base. Each MSTG is preferably equipped with a front-end axial spline to fit into the large diameter shaft of the 45″ drive gear to split power from the 108″ bull gear. This arrangement permits rapid removal and replacement of the MSTG module anchored to the bull gear/drive gear frame. Note that each MSTG is preferably a self-contained, sealed module.

As best seen in FIG. 5, the MSTG preferably comprises five primary geared components, it being understood that embodiments are possible with virtually any number of such primary geared components. The gears will preferably use a 30° helix angle (to result in an increased contact ratio of 2 to 4 in the gear meshes) and a 25° pressure angle (recommended for amplification). Each of these components is described in greater detail below.

In a preferred embodiment, the bull gear is directly supported by a cross roller bearing to give it high structural support and to carry the heavy thrust load due to the helical teeth. In one exemplary embodiment, the bull gear is 108″ in diameter and contains 130 teeth, and the associated drive gear is 45″ in diameter and contains 54 teeth. The bull gear rotates at 20 RPM, and the drive gear rotates at 48 RPM. The drive gear has a 146,200 ft-lb. input torque, and the Mesh 1 has a contact force of 77,955 lb. with a velocity of 9.4 ft/sec.

In a preferred embodiment, Module A is a star compound 2-plane gear amplifier. In an exemplary embodiment, it has a 146,200 ft/lb. input torque. Mesh 2 in this embodiment is composed on input pinion of 20″ and 62 teeth with output star gear of 8.764″ and 27 teeth for a 2.282 amplification ratio. The contact mesh force is 58,496 lb. with a velocity of 4.19 ft/sec. Mesh 3 in this embodiment is made up of a 20″ star gear of 62 teeth and an 8.764″ output pinion gear for an amplification ratio of 2.282. This mesh experiences a contact force of 25,633 lb. and a velocity of 9.53 ft/sec. The overall amplification ratio for this embodiment is 5.208.

In a preferred embodiment, Module 1 contains three planes of gears with meshes 4, 5, and 6. Meshes 4 and 5 are connected to the input shaft with a clutch to enable a velocity gain of 1 and 1.33 (i.e., a shift ratio of 1.33). In an exemplary embodiment, mesh 4 involves a 10″ pinion gear and a 10″ star gear. The input shaft has 28,068 ft-lb. of torque, which results in a star gear torque of 9.356 ft-lb. (there are three star gears), a contact force of 22,454 lb. and a mesh velocity of 10.9 ft/sec. Mesh 5 involves a 11.42″ pinion of 36 teeth and a 8.56″ star gear of 27 teeth, for an amplification ratio of 1.33. The contact force is 19,662 lbs., and has an associated mesh velocity of 12.65 ft/sec. The torque on the star gear is 7,017 ft-lb. Mesh 6 uses three star gears to mesh with an output pinion. The maximum star gear torque is 9,356 ft-lb., which makes the output torque 14,034 ft-lb. and a contact force of 16,858 lb. due to an amplification ratio of 2 with a mesh velocity of 14.49 ft/sec. The star gear diameter is 13.32″ with 54 teeth and a pinion diameter of 6.66″ and 27 teeth.

In a preferred embodiment, Module 2 contains three planes of gears 7, 8, and 9 with a clutch between planes 7 & 8 to provide amplification ratios of 1 and 2 (or a total shift ratio of 2). In an exemplary embodiment, the module has an input torque of 14,034 ft.-lb. In this embodiment, mesh 7 involves an input pinion of 10″ diameter and a star gear of 10″ diameter, both containing 27 teeth with a mesh velocity of 22.3 ft/sec. The contact force is 11,227 lb. This results in an amplification ratio of 1. The torque on the star gears in this exemplary embodiment is 4,678 ft-lb. Mesh 8 provides an amplification ratio of 2 to result in a star gear torque of 2,339 ft-lb. The pinion gear is 13.32″ with 54 teeth and the star gear is 6.66″ with 27 teeth. The contact force in this exemplary embodiment is 8,429 lb. with a mesh velocity of 14.49 ft/sec. Mesh 9 is a single plane star compound amplifier with star gears of 13.32″ and 54 teeth and the pinion gear of 6.66″ and 27 teeth. The maximum star gear torque is 4,678 ft-lb., which results in an output pinion torque of 2,017 ft-lb. due to the amplification ratio of 2. The contact force in this mesh is 8,423 lb. with a mesh velocity of 28.78 ft/sec.

The gear parameters for these 9 gear meshes are tabulated in TABLE 12. The contact ratio for the 30° helix gear teeth is based on Elements of Metric Gear Technology by Cheng (1966).

TABLE 12
Gear Mesh Definition and Parameters

| | | Gear 1 | | Gear 2 | | | | |
|---|---|---|---|---|---|---|---|---|
| | Gear 1 | Pitch | Gear 2 | Pitch | Face | Diametral | | |
| Gear | Teeth | Diameter | Teeth | Diameter | Width | Pitch | Module | Contact |
| Mesh | Count | (in.) | Count | (in.) | (in.) | (1/in.) | (mm/1) | Ratio |
| 1 | 54 | 45 | 130 | 108 | 6 | 1.2 | 21.1667 | 2.8992 |
| 2 | 62 | 20 | 27 | 8.764 | 6 | 3.0808 | 8.2447 | 3.7724 |
| 3 | 62 | 20 | 27 | 8.764 | 4 | 3.0808 | 8.2447 | 3.7724 |
| 4 | 27 | 20 | 27 | 20 | 3 | 1.35 | 18.8148 | 2.2026 |
| 5 | 27 | 8.764 | 36 | 11.68 | 3 | 3.0808 | 8.2447 | 3.1768 |
| 6 | 27 | 6.66 | 54 | 13.32 | 3 | 4.0541 | 6.2653 | 3.7363 |
| 7 | 27 | 10 | 27 | 20 | 2 | 2.7 | 9.4074 | 2.4507 |
| 8 | 27 | 6.66 | 54 | 13.32 | 2 | 4.0541 | 6.2653 | 2.9913 |
| 9 | 27 | 6.66 | 54 | 13 | 2 | 4.0541 | 6.2653 | 2.9913 |

The AGMA has presented all necessary formulations for gear bending and contact stress calculations. The gear tooth numbers, diameters, and contact ratios are given in TABLE 12. TABLE 13 provides the bending geometry factor J and contact geometry factor I for the bending and contact stress formulas.

$$\begin{matrix}Bending {S}_{t} = \frac{{F}_{c} {K}_{v} {K}_{m} {P}_{d}}{{\overline{C}}_{r} W , J} & ( EQUATION 10 ) \\ Contact {S}_{c} = \frac{{C}_{p}}{{\overline{C}}_{r}} \sqrt{\frac{{F}_{c} {K}_{v} {K}_{m}}{{d}_{p} WI}} & ( EQUATION 11 )\end{matrix}$$

where
F_{c}—tangential tooth load (lbs.)
KᵥKₘ—duty cycle coefficient (≈1.5)
Cₚ— elastic coefficient
J—bending geometry factor
I—contact geometry factor
P_{d}— diametral pitch of pinion gear
W—face width
C̅ᵣ— effective contact ratio

TABLE 13
Gear Mesh Geometric Bending (J) and Contact (I)
Factors, Based on FIG. 2 Data

| | Geometric Bending | Geometric Contact |
|---|---|---|
| Mesh | Factor | Factor |
| 1 | 0.65 | 0.212 |
| 2 | 0.59 | 0.2 |
| 3 | 0.59 | 0.2 |
| 4 | 0.58 | 0.141 |
| 5 | 0.58 | 0.141 |
| 6 | 0.59 | 0.196 |
| 7 | 0.58 | 0.141 |
| 8 | 0.59 | 0.196 |
| 9 | 0.59 | 0.196 |

The resulting stress values for the nine meshes is given in TABLE 14. The gear parameter selection has been purposely conservative to result in very low stress values to lead to a very long life cycle of 20 to 25 years.

TABLE 14
Approximate Stresses Normalized by Contact Ratio

| | Effective Contact | | |
|---|---|---|---|
| Mesh | Ratio | Bending Stress (psi) | Contact Stress (psi) |
| 1 | 2 | 17818 | 51730 |
| 2 | 4 | 25,408 | 69,955 |
| 3 | 3 | 16563 | 56490 |
| 4 | 2 | 12935 | 72197 |
| 5 | 3 | 17232 | 68039 |
| 6 | 3 | 19112 | 61298 |
| 7 | 2 | 19402 | 88423 |
| 8 | 2 | 21494 | 79614 |
| 9 | 2 | 10749 | 56302 |

Preferably, each contact of a 30° helix tooth results in a 60% thrust load relative to the tooth contact force. Going to a 45° helix angle would raise this to 100%. Notably, all meshes 2-9 use three star gears which have three contact forces with the central pinion gear. These radial contact forces all balance so no radial forces act on the pinion shaft bearings. However, the three contact forces would add up to a thrust force of ≈170% of the radial contact force (at each mesh). Hence, thrust forces are of very high importance in the preferred embodiment of the MSTG disclosed herein.

Two complementary approaches may be taken. The first involves the use of opposing helix angles to partially cancel opposing thrust forces. The second involves use of at least one very compact cross roller (an alternative is to use a grooved roller bearing (GRB) on each end of the shaft with significant thrust forces) bearing on each independent gear axis. The following is a sequence of design steps.

Mesh 1—This involves the bull gear and the drive gear. Support the bull gear with a large diameter small cross-section cross roller bearing combined with herringbone teeth in the mesh.

Mesh 1, 2—This involves the drive gear and the first pinion of Module A. Use both opposing helix angles and a cross roller bearing on the first axis.

Mesh 2, 3—These two meshes on the star gears in Module A could use opposing helix angles to cancel the thrust forces and a cross roller bearing on one end of the star shafts.

Mesh 3, 4—This shaft between Module A and Module 1 has a pair of pinion gears with large thrust loads. Use opposing helix angles to partially cancel the thrust load and a cross roller bearing to support the pinion shaft.

Star Gears—Both Modules 1 and 2 will have three star gears with meshes 3 to 9. Each star gear axis will contain three gears where the first two are driven by a pinion selected by a clutch in either Module 1 or 2.

When the first star gear is engaged it must drive the output star gear and, therefore, balance the thrust forces between these two gears. Similarly, for the second star gear. Each star gear axis should also be supported by a cross roller bearing.

Meshes 5 & 6—This is a pinion shaft in Module 1. It has to balance the first pinion gear and the second pinion gear. It should also use a cross roller bearing on one end of the pinion shaft.

Meshes 7 and 8—This is the same as Meshes 5 & 6.

Mesh 9—The output pinion of the MSTG has no means to balance its thrust force (although relatively small). Hence, a cross roller bearing should be used to support this last pinion shaft.

All of these stresses are relatively low except Mesh 2 which has a bending stress of 25,408 psi. This can be reduced by taking the width of the gear from 6″ to 7″, increasing the effective contact ratio to 4 and bringing the bending stress down to 19,155 psi, compatible with others listed in TABLE 4. Increasing the Mesh 8 width to 2.2″ would reduce stress to 14,315 psi.

The AGMA published allowable bending stresses in Grade 2, carbonized and hardened, high quality steel, class 10 to 12 quality, and operating at 10¹⁰ cycles gives a value of 52,000 to 56,000 psi.

The values listed in TABLE 1 are 20,000 psi or less, so that the design for durability margin is 2.7×, which is highly desirable.

The similar AGMA contact stress values are 144,000 psi. Increasing the width of Mesh 7 to 3″ would reduce the contact stress to 59,200 psi so that the mean upper contact stress among these gear meshes is near 72,000 psi. Hence, the design for durability is 2.0×, which is also highly desirable.

The present parameters for the dimensions of a preliminary embodiment of the MSTG modules are set forth in TABLE 15 below.

TABLE 15
Preliminary Gearbox Design

| | | Interior Diameter |
|---|---|---|
| Module | Length (inches) | (AmpGears) (Inches) |
| A | 15 | 42 |
| 1 | 18 | 37.5 (34.3) |
| 2 | 14 | 33.3 (33.3) |

All gears in this design preferably utilize 1″ webbed connecting plates between their gear rims and bearing collars to reduce weight. All support walls and outer cylinder shells are also preferably webbed to maintain strength and to reduce weight. A rough estimate of the weight of these 3 modules using high quality steel would be 5000 lb. each.

Another opportunity is available to reduce torque demands on Modules 1 and 2. Research suggested a two mesh front end with the bull gear tied to the rotor hub with an amplification ratio of 9 to 1. When Module A was inserted, its amplification ratio was restricted to 5.208 to 1. In fact, it could be as high as 6.25 to 1 if the internal amplification ratios were raised to 2.5 to 1. This would reduce the torques on Modules 1 and 2 by approximately 20%, which would still maintain the system's functional flexibility but at a reduced weight.

Preferably, the front end bull gear is tied directly to the rotor hub by means of a super light but rugged large diameter (for example, 100″), small cross-section cross roller bearing. This bearing housing is preferably structurally tied to the vertical axis yaw bearing with shortest possible distance to further reduce weight. Doing so may compensate for the weight of the 108″ bull gear and the 45″ drive gears for each of the MSTG subsystem generators.

The design choices in this section are for very conservative values to maximize durability and lower maintenance issues. It is possible to aggressively choose the largest gear amplifications in the switch modules 1, 2, and eliminate Module A in favor of a simple pair of meshes between the bull gear and Module 1. Doing so would reduce complexity, number of parts, and certainly weight. The first two meshes would be 3 to 1 amplifiers to give a total of 9 to 1. In such an embodiment, Module 1 would contain:
Mesh 1=>1 to 1
Mesh 2=>1.75 to 1
Mesh 3=>3 to 1
   Module 2 would contain:
Mesh 1=>1 to 1
Mesh 2=>3 to 1
Mesh 3=>3 to 1
   Hence, the total reduction sequence would be:

| | | | |
|---|---|---|---|
| 81 | 141.75 | 243 | 425.25 |

which is dramatically different than conservative sequence:

| | | | |
|---|---|---|---|
| 50 | 66.7 | 100 | 133 |

used in this numerical example. The higher value of 81 (versus 50) and 425.25 (versus 133) means more concern for a lower wind speed distribution (see Sec. III). The shift ratio increases from 2.666 up to 5.25 and the torsional load on Module 2 are significantly reduced. Hence, the choice of these mesh ratios are the crucial first steps in a design of the MSTG-based system.

The above description of the present invention is illustrative, and is not intended to be limiting. It will thus be appreciated that various additions, substitutions and modifications may be made to the above described embodiments without departing from the scope of the present invention. Accordingly, the scope of the present invention should be construed in reference to the appended claims. It will also be appreciated that the various features set forth in the claims may be presented in various combinations and sub-combinations in future claims without departing from the scope of the invention. In particular, the present disclosure expressly contemplates any such combination or sub-combination that is not known to the prior art, as if such combinations or sub-combinations were expressly written out.

1. A wind turbine, comprising:
a blade;
a shaft which rotates in response to the rotation of said blade;
a generator; and
a star compound gear train disposed between said shaft and said generator.

2. The wind turbine of claim 1, wherein said at least one blade includes a plurality of blades.

3. The wind turbine of claim 1, wherein said gear train comprises:
a cross-roller bearing;
a bull gear supported on said cross-roller bearing; and
a drive gear which meshes with the bull gear via a first mesh.

4. The wind turbine of claim 3, wherein said gear train further comprises:
a star compound 2-plane gear amplifier.

5. The wind turbine of claim 4, wherein said gear train further comprises:
an input pinion; and
an output star gear which meshes with said input pinion via a second mesh.

6. The wind turbine of claim 5, wherein said gear train further comprises:
an output pinion; and
a star gear which meshes with said output pinion via a third mesh.

7. The wind turbine of claim 6, wherein said gear train further comprises:
first, second and third planes of gears with fourth, fifth and sixth respective associated meshes.

8. The wind turbine of claim 7, wherein said gear train further comprises an input shaft, and wherein said fourth and fifth meshes are connected to said input shaft by way of a clutch.

9. The wind turbine of claim 8, wherein said fourth mesh involves a pinion gear and a star gear.

10. The wind turbine of claim 8, wherein said fifth mesh involves a pinion gear and a star gear.

11. The wind turbine of claim 8, wherein said sixth mesh involves three star gears and an output pinion.

12. The wind turbine of claim 7, wherein said gear train further comprises:
fourth, fifth and sixth planes of gears with seventh, eighth and ninth respective associated meshes.

13. The wind turbine of claim 12, further comprising a clutch disposed between the fourth and fifth planes of gears.

14. The wind turbine of claim 13, wherein the seventh mesh involves an input pinion and a star gear.

15. The wind turbine of claim 13, wherein the eighth mesh provides an amplification ratio.

16. The wind turbine of claim 13, wherein the ninth mesh involves a single plane star compound amplifier with star gears and a pinion gear.
